(19) United States
(12) Patent Application Publication
(10) Pub. No.: US 2011/0307849 A1
(43) Pub. Date: Dec. 15, 2011

(54) LOGICAL DESCRIPTION DIFFERENCE EXTRACTING METHOD, LOGICAL DESIGN AIDING APPARATUS, AND NON-TRANSITORY COMPUTER-READABLE STORAGE MEDIUM THEREOF

(75) Inventors: Hiroji TAKEYAMA, Kawasaki (JP); Kazuhiro MATSUZAKI, Kawasaki (JP); Shuichiro YAMADA, Kawasaki (JP)

(73) Assignee: FUJITSU LIMITED, Kawasaki-shi (JP)

(21) Appl. No.: 13/074,688

(22) Filed: Mar. 29, 2011

(30) Foreign Application Priority Data
Jun. 11, 2010 (JP) 2010-133611

(51) Int. Cl. G06F 17/50

(52) U.S. Cl. 716/107

(57) ABSTRACT

A logical description aiding apparatus identifies a positional relation between a position of an uncorrected description part of an after-correction logical description and a position of a corresponding description part of a before-correction logical description. After that, the logical description aiding apparatus identifies, using the identified positional relation, a position where before-correction check results are accordant with after-correction check results and conducts message replacement so that the format of a message of a before-correction check result located on the identified position is changed to the same format as the format of messages of the after-correction check results. The logical description aiding apparatus then extracts differences between the format-changed before-correction check results and the after-correction check results.

### CROSS-REFERENCE TO RELATED APPLICATION

This application is based upon and claims the benefit of priority of the prior Japanese Patent Application No. 2010-133611, filed on Jun. 11, 2010, the entire contents of which are incorporated herein by reference.

### FIELD

The embodiments discussed herein are directed to a logical description difference extracting method, a logical design aiding apparatus, and a non-transitory computer-readable storage medium having stored therein a logical description difference extracting program.

### BACKGROUND

In modern logical circuit designing, a style called register transfer level (RTL) is frequently used for hardware description. Because most RTL-based hardware description is conducted manually, the contents of the description may include errors.

In order to prevent a description content error, a logical design aiding apparatus that aids designing logical circuits checks validity of hardware description and outputs a check result. More particularly, the logical design aiding apparatus checks the validity of the hardware description using a style check tool and outputs a warning message, etc., as a check result.

Therefore, a user can correct the hardware description language with reference to the check result of the logical design aiding apparatus. However, there is the possibility that the user makes a new mistake during correction. Therefore, the validity of the after-correction hardware description is also checked using the style check tool.

As described above, the logical design aiding apparatus checks each of the validity of the before-correction hardware description and the validity of the after-correction hardware description using the style check tool.

If the logical design aiding apparatus conducts a strict validity check using a style check tool, many warning messages may be output when each hardware description is checked and the user may not understand which warning message is important.

A well-known technology that helps user's understanding involves extracting differences between results of a check for the before-correction hardware description and results of a check for the after-correction hardware description and outputting only some check results appearing after correction of the hardware description. Uncorrected parts are excluded because they are determined to be minor warnings. For example, the position of a corrected part of the hardware description is identified using a definition position independent from the line number; check results are separated into groups by new error, uncorrected, and checked; and differences are extracted automatically.
Patent Document 1: Japanese Laid-open Patent Publication No. 2005-044023
Patent Document 2: Japanese Laid-open Patent Publication No. 05-334062
Patent Document 3: Japanese Laid-open Patent Publication No. 2000-207440
Patent Document 4: Japanese Laid-open Patent Publication No. 2004-126866
Patent Document 5: Japanese Laid-open Patent Publication No. 2007-034584

However, the above conventional technologies work appropriately only when the style check tool used for before-correction software description is the same as the style check tool used for after-correction software description and cannot work appropriately when the style check tools are different. This is simply because, if the style check tool used for before-correction software description is different from the style check tool used for after-correction software description, differences between the check results cannot be extracted. Even if the style check tool used for before-correction software description is the same as the style check tool used for after-correction software description, if settings of output formats are different, the same problem occurs.

### SUMMARY

According to an aspect of an embodiment of the invention, a logical description difference extracting method includes: extracting a difference between before-correction check results and after-correction check results, wherein the before-correction check results are results of a check for a before-correction logical description using a first style check tool, the after-correction check results are results of a check for an after-correction logical description using a second style check tool, and a format of messages of the first style check tool is different from a format of messages of the second style check tool; identifying a positional relation between a position of an uncorrected description part of the after-correction logical description and a position of a corresponding description part of the before-correction logical description; identifying, using the positional relation identified in the identifying, a position where the before-correction check results are accordant with the after-correction check results and conducting message replacement so that the format of a message of a before-correction check result located on the identified position is changed to the same format as the format of messages of the after-correction check results; and extracting a difference between the before-correction check results format-changed in the message replacement and the after-correction check results.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram of the configuration of a logical design aiding apparatus according to the first embodiment;

FIG. 2 is a block diagram of a logical design aiding apparatus according to the second embodiment;

FIG. 3 is a schematic diagram of examples of style check results;

FIG. 4 is a schematic diagram that illustrates a message-dictionary creating process;

FIG. 5 is a schematic diagram of the format of a first message dictionary;

FIG. 6 is a schematic diagram of the format of a second message dictionary;

FIG. 7 is a schematic diagram of the format of a third message dictionary;

FIG. 8 is a schematic diagram of examples of format file description;

FIG. 9 is a schematic diagram that illustrates a style check result difference extracting process;

FIG. 10 is a schematic diagram that illustrates how messages are separated into groups;

FIG. 11 is a schematic diagram that illustrates how differences between style check results are extracted;

FIG. 12 is a sequence diagram of a process performed by the logical design aiding apparatus according to the second embodiment;

FIGS. 13A and 13B are a sequence diagram of a process performed by the logical design aiding apparatus according to the second embodiment;

FIG. 14 is a sequence diagram of a process performed by the logical design aiding apparatus according to the second embodiment; and

FIG. 15 is a block diagram of a computer that executes a logical description difference extracting program.

### DESCRIPTION OF EMBODIMENTS

Preferred embodiments of the present invention will be explained with reference to accompanying drawings.

### [a] First Embodiment

In the following, the configuration of a logical design aiding apparatus according to the first embodiment and the processes performed by the logical design aiding apparatus are described. A logical design aiding apparatus 1 according to the first embodiment obtains before-correction check results that are results of check for a before-correction logical description using a first style check tool. The logical design aiding apparatus 1 then obtains after-correction check results that are results of check for an after-correction logical description using a second style check tool. The format of messages of the first style check tool is different from the format of messages of the second style check tool. After that, the logical design aiding apparatus 1 extracts differences between the before-correction check results and the after-correction check results.

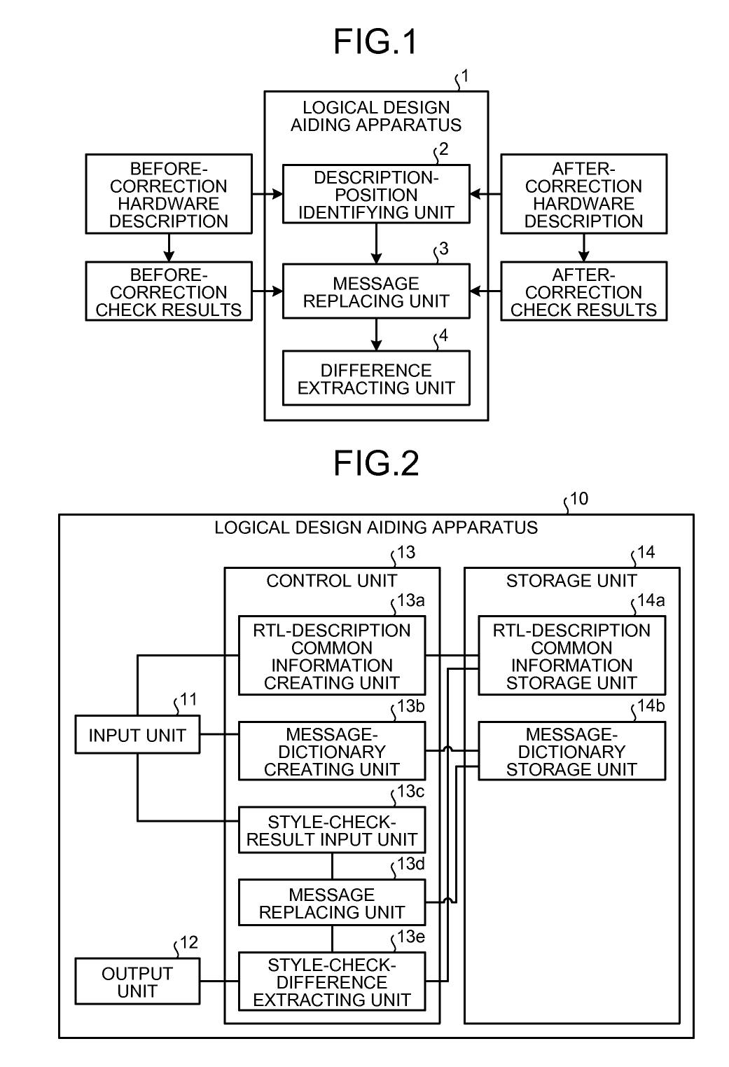

As illustrated in FIG. 1, the logical design aiding apparatus 1 includes a description-position identifying unit 2, a message replacing unit 3, and a difference extracting unit 4. FIG. 1 is a block diagram of the configuration of the logical design aiding apparatus according to the first embodiment. The description-position identifying unit 2 identifies a positional relation between the position of an uncorrected description part of the after-correction logical description and the position of the corresponding description part of the before-correction logical description.

The message replacing unit 3 identifies, using the positional relation identified by the description-position identifying unit 2, a position where the before-correction check results are accordant with the after-correction check results. The message replacing unit 3 then conducts message replacement so that the format of a message of a before-correction check result located on the identified position is changed to the same format as the format of messages of the after-correction check results.

The difference extracting unit 4 extracts differences between the before-correction check results format-changed by the message replacing unit 3 and the after-correction check results.

With this configuration, even if the style check tool with which the before-correction hardware description is checked is different from the style check tool with which the after-correction hardware description is checked, differences are extracted exactly between check results.

### [b] Second Embodiment

In the following embodiment, the configuration of a logical design aiding apparatus according to the second embodiment is described first, then the processing flow is described, and finally the effects of the second embodiment are described. In the following example, the type of the style check tool with which the style of the before-correction hardware description is checked is different from the type of the style check tool with which the style of the after-correction hardware description is checked.

Configuration of the Logical Design Apparatus

The configuration of a logical design aiding apparatus 10 is described with reference to FIG. 2. FIG. 2 is a block diagram of the logical design aiding apparatus 10 according to the second embodiment. As illustrated in FIG. 2, the logical design aiding apparatus 10 includes an input unit 11, an output unit 12, a control unit 13, and a storage unit 14. The processes performed by the above units are described in the following.

The input unit 11 inputs contents of before-correction RTL-based hardware description (hereinafter, “RTL1”), contents of after-correction RTL-based hardware description (hereinafter, “RTL2”), results of check for the hardware descriptions using style check tools, etc.

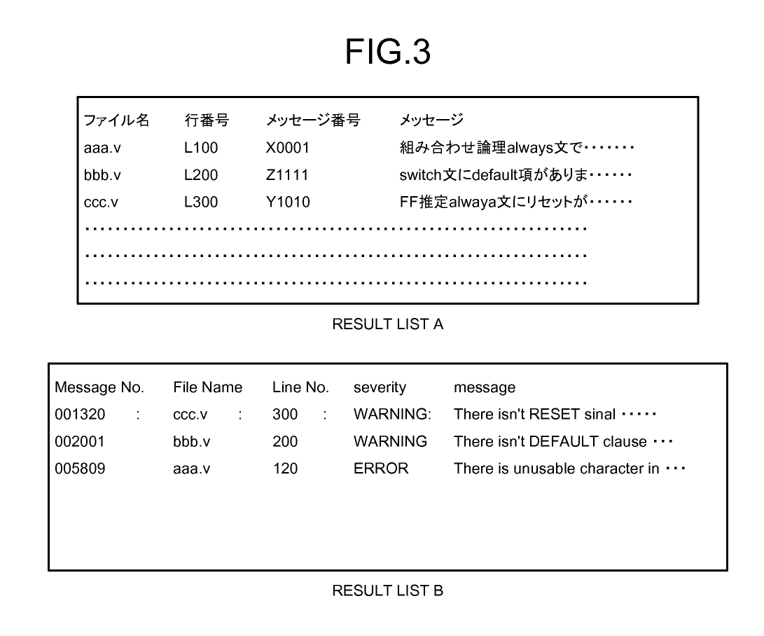

Examples of results of check using style check tools are described below with reference to FIG. 3. FIG. 3 is a schematic diagram of examples of style check results. The examples of FIG. 3 include a result list A and a result list B. The result list A contains results of check for the before-correction hardware description using a style check tool A. The result list B contains results of check for the after-correction hardware description using a style check tool B. As illustrated in the examples of FIG. 3, the format of messages of the style check tool A is different from the format of messages of the style check tool B.

The output unit 12 outputs differences between check results A that are results of check for the before-correction hardware description using the style check tool A and check results B that are results of check for the after-correction hardware description using the style check tool B.

The storage unit 14 stores therein data and programs that are needed when the control unit 13 performs various processes. The storage unit 14 includes an RTL-description common information storage unit 14a and a message-dictionary storage unit 14b. The RTL-description common information storage unit 14a stores therein a description content common to both the RTL1 and the RTL2. The RTL-description common information storage unit 14a further stores therein the line number of a part of the RTL1 and the line number of a part of the RTL2 both having the same description content, relating the line numbers to each other.

The message-dictionary storage unit 14b stores therein messages of the style check tool A with which the style of the before-correction hardware description is checked and messages of the style check tool B with which the style of the after-correction hardware description is checked, relating the messages to each other.

More particularly, the message-dictionary storage unit 14b includes a first message dictionary 1 that contains messages of the style check tool A and respective messages of the style check tool B on a one-to-one basis. The message-dictionary storage unit 14b further includes a second message dictionary 2 that contains messages of either the style check tool A or style check tool B that has no corresponding message.

The message-dictionary storage unit 14b further includes a third message dictionary 3 that contains messages of the style check tool A and respective messages of the style check tool B on many-to-many basis. The above message dictionaries will be described in details later with reference to FIGS. 6 to 8.

The control unit 13 has an internal memory that stores therein programs in accordance with which various processes are performed and required data. The control unit 13 performs various processes using the programs and the data. The control unit 13 includes an RTL-description common information creating unit 13a, a message-dictionary creating unit 13b, a style-check-result input unit 13c, a message replacing unit 13d, and a style-check-difference extracting unit 13e.

The RTL-description common information creating unit 13a stores, if there are a part of the before-correction hardware description and a part of the after-correction hardware description both having the same description content, the file name, the line number, and the description content of each part in the RTL-description common information storage unit 14a.

Moreover, the RTL-description common information creating unit 13a identifies a positional relation between the position of an uncorrected description part of the after-correction hardware description and the position of the corresponding description part of the before-correction hardware description.

More particularly, upon receiving the RTL1, which is the before-correction hardware description, and the RTL2, which is the after-correction hardware description, from the input unit 11, the RTL-description common information creating unit 13a searches for modules having the same name from the received RTL1 and the received RTL2. The module is a structural unit of RTL.

In the Verilog-HDL language, for example, a piece of data started with “module name” and ended with “endmodule” forms one unit. In the VHDL language, each of a piece of data started with “entity name” and “end name” and a piece of data started with “architecture architecture name of entity name” and ended with “end architecture name” forms one unit.

If modules having the same name are found in both the RTL1 and the RTL2, the RTL-description common information creating unit 13a determines whether there are a part of the before-correction hardware description and a part of the after-correction hardware description both having the same description content.

If parts having the same description content are found, the RTL-description common information creating unit 13a relates the file name, the line number, and the description content of the part of the RTL1 to the file name, the line number, and the description content of the part of the RTL2, respectively and stores them in the RTL-description common information storage unit 14a. Because the parts having the same description content are stored being related to each other, it is possible to analyze a correspondence relation between the position of a message of the RTL1 and the position of a message of the RTL2 that has the same description content as that of the message of the RTL1.

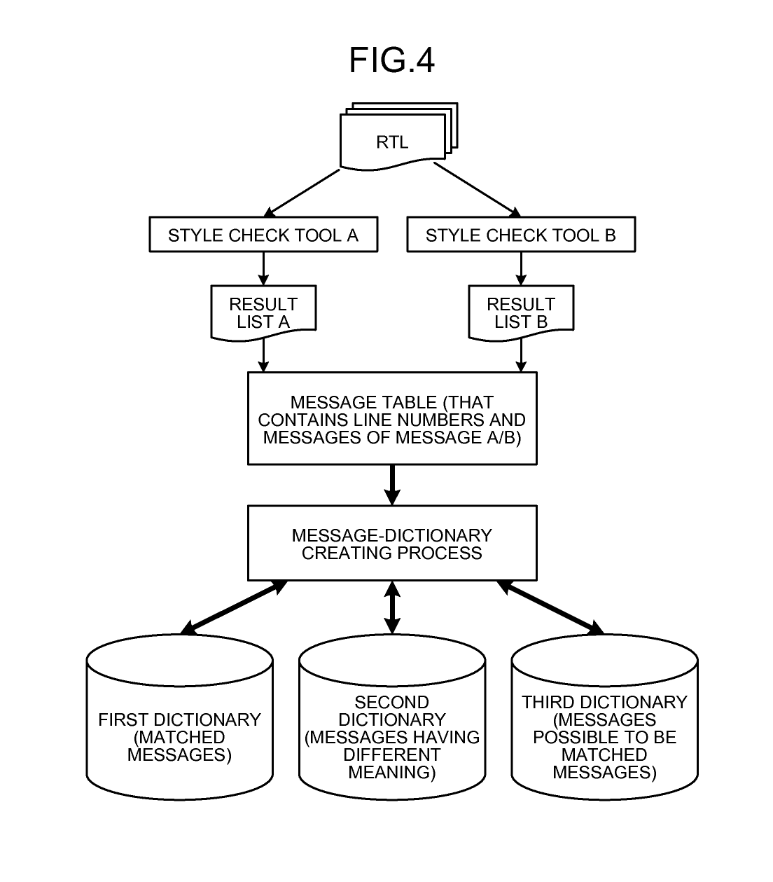

The message-dictionary creating unit 13b creates a message dictionary that contains messages of the style check tool A and messages of the style check tool B on one-to-one basis. More particularly, as illustrated in FIG. 4, the message-dictionary creating unit 13b checks the same RTL-based hardware description using each of the style check tool A and the style check tool B. FIG. 4 is a schematic diagram that illustrates the message-dictionary creating process.

The message-dictionary creating unit 13b checks the RTL-based hardware description using the style check tool A, thereby obtaining a check result list A and also checks the same RTL-based hardware description using the style check tool B, thereby obtaining a check result list B. After that, the message-dictionary creating unit 13b extracts line numbers and message main bodies from each of the check result list A and the check result list B and then creates a correspondence table A and a correspondence table B.

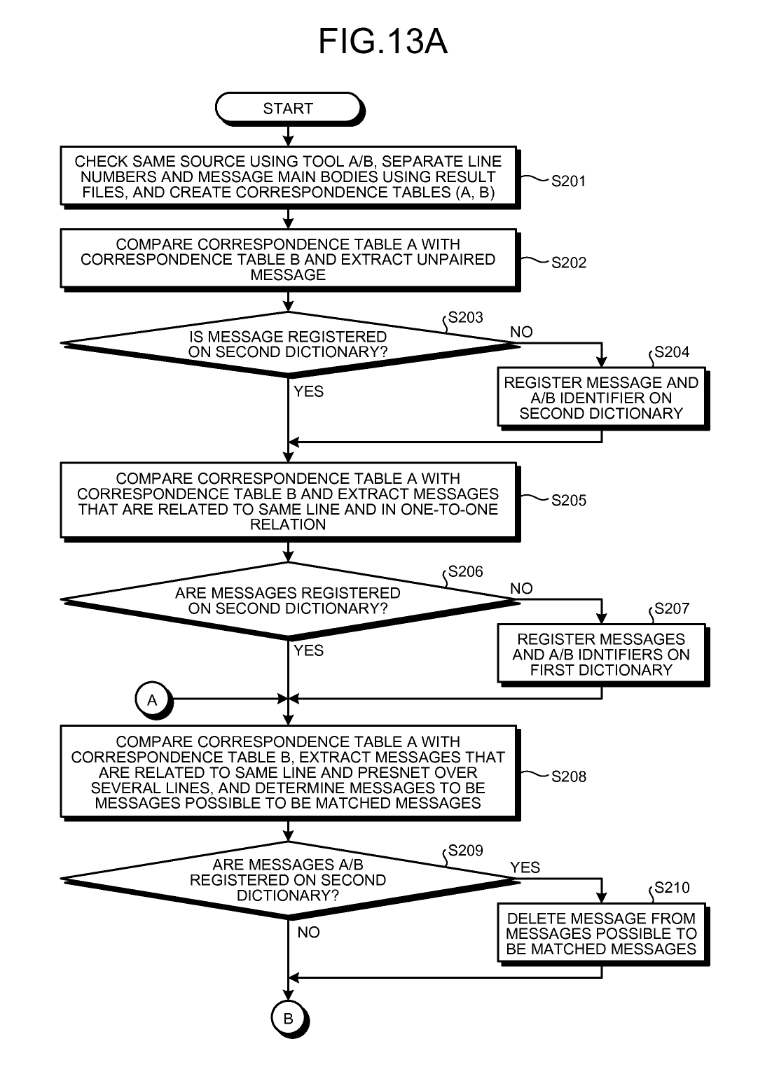

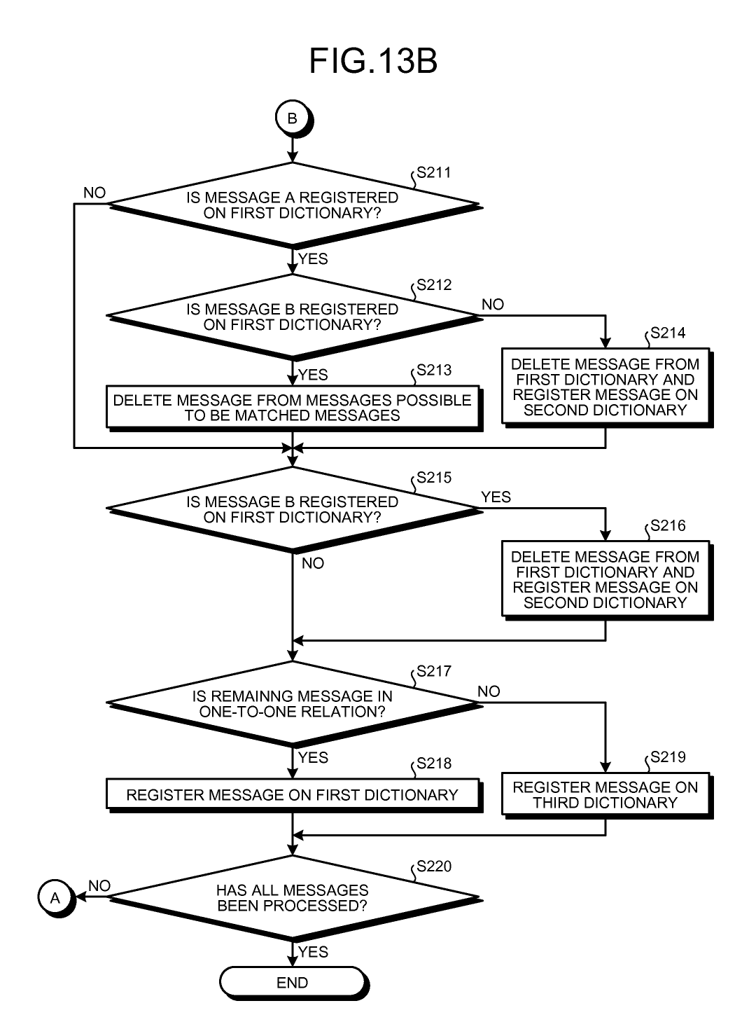

The message-dictionary creating unit 13b performs a process for creating a message dictionary (that will be described in details later with reference to FIGS. 13A and 13B) and determines whether a message of either the style check tool A or the style check tool B has a one-to-one relation with a message of the other style check tool.

If the message-dictionary creating unit 13b determines that a message of either the style check tool A or the style check tool B has a one-to-one relation with a message of the other style check tool, it relates the messages to each other and stores them in the first message dictionary.

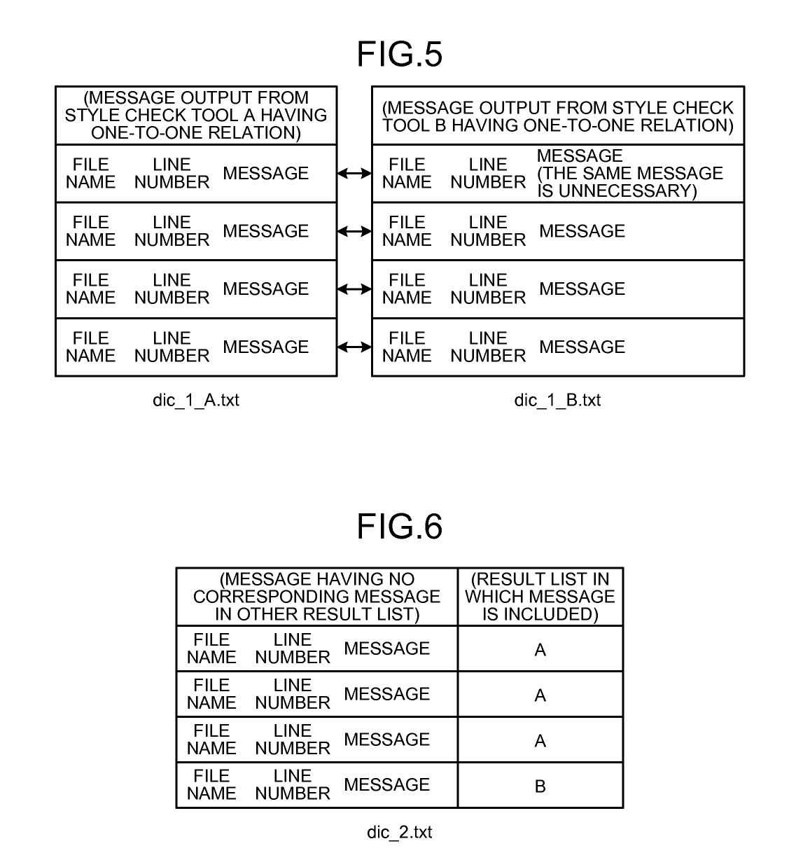

As illustrated in FIG. 5, the first message dictionary stores therein the “messages” that are in the one-to-one relation and one message being output from the style check tool A and the other message being output from the style check tool B, the “line numbers” indicative of the numbers of the lines that includes the respective messages, and the “file names” indicative of the names of the files. FIG. 5 is a schematic diagram of the format of the first message dictionary.

If the message-dictionary creating unit 13b determines that a message of either the style check tool A or the style check tool B does not have a one-to-one relation with any message of the other style check tool, it stores the unpaired message in the second message dictionary.

As illustrated in FIG. 6, the second message dictionary stores therein the message that is output from either the style check tool A or the style check tool B, the line number indicative of the number of the line that includes the message, the file name, and the style check tool name being related to each other. FIG. 6 is a schematic diagram of the format of the second message dictionary.

If the message-dictionary creating unit 13b determines that there are several messages on the same line and the messages of either the style check tool A or the style check tool B have a many-to-many relation with messages of the other style check tool, it stores the messages in the third message dictionary.

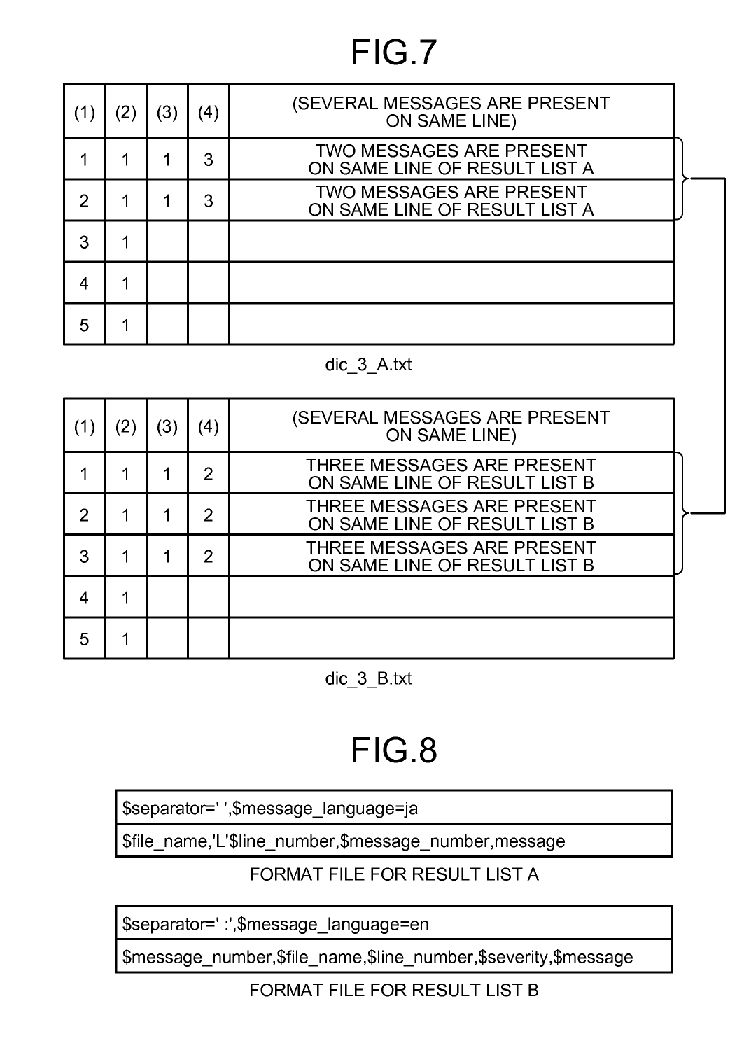

As illustrated in FIG. 7, the third message dictionary relates a plurality of messages on the same line of the style check tool A to a plurality of messages on the same line of the style check tool B and stores therein the messages. FIG. 7 is a schematic diagram of the format of the third message dictionary. In the example of illustrated in FIG. 7, the third message dictionary has items (1) and (2): the item (1) has the address of a message in the dictionary, and the item (2) has the invalid flag (if the invalid flag is 1, the message is present in the dictionary, while the invalid flag is 0, the message is deleted from the dictionary).

The third message dictionary further has items (3) and (4): the item (3) has the head of the message address in the corresponding style check tool, and the item (4) has the end of the message address of the corresponding style check tool.

The style-check-result input unit 13c reads the before-correction check result list and the after-correction check result list in accordance with the formats. More particularly, the style-check-result input unit 13c has different format files on the style check tool basis.

As illustrated in the example of FIG. 8, the style-check-result input unit 13c has a format file for the check result list A corresponding to the style check tool A and another format file for the check result list B corresponding to the style check tool B.

In other words, there are two lists, a result list 1A that contains results of description check for the RTL1 using the style check tool A, and a result list 2B that contains results of description check for the RTL2 using the style check tool B. Because the formats of the lists are different, the style-check-result input unit 13c cannot read the lists in the same manner. Therefore, the style-check-result input unit 13c reads the style check result lists in accordance with the respective formats of the style check tools.

The message replacing unit 13d identifies, using the positional relation identified by the RTL-description common information creating unit 13a, a position where the before-correction check results are accordant with the after-correction check results. The message replacing unit 13d then conducts message replacement so that the format of a message of a before-correction check result located on the identified position is changed to the same format as the format of messages of the after-correction check results.

More particularly, The message replacing unit 13d searches the first message dictionary using a message of a before-correction check result read by the style-check-result input unit 13c as a key. If a message that has the same content is found, the message replacing unit 13d replaces the message with the message of the style check tool B.

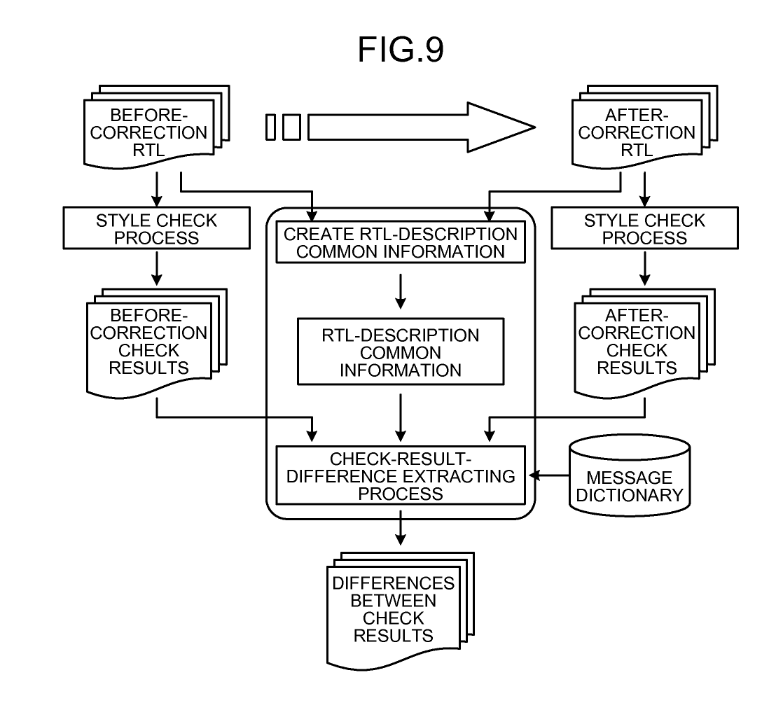

The style-check-difference extracting unit 13e extracts differences between the before-correction check results format-changed by the message replacing unit 13d and the after-correction check results. More particularly, as illustrated in FIG. 9, the style-check-difference extracting unit 13e received the before-correction check results and the after-correction check results from the style-check-result input unit 13c and obtains the RTL-description common information and the first message dictionary. FIG. 9 is a schematic diagram that illustrates the style check result difference extracting process.

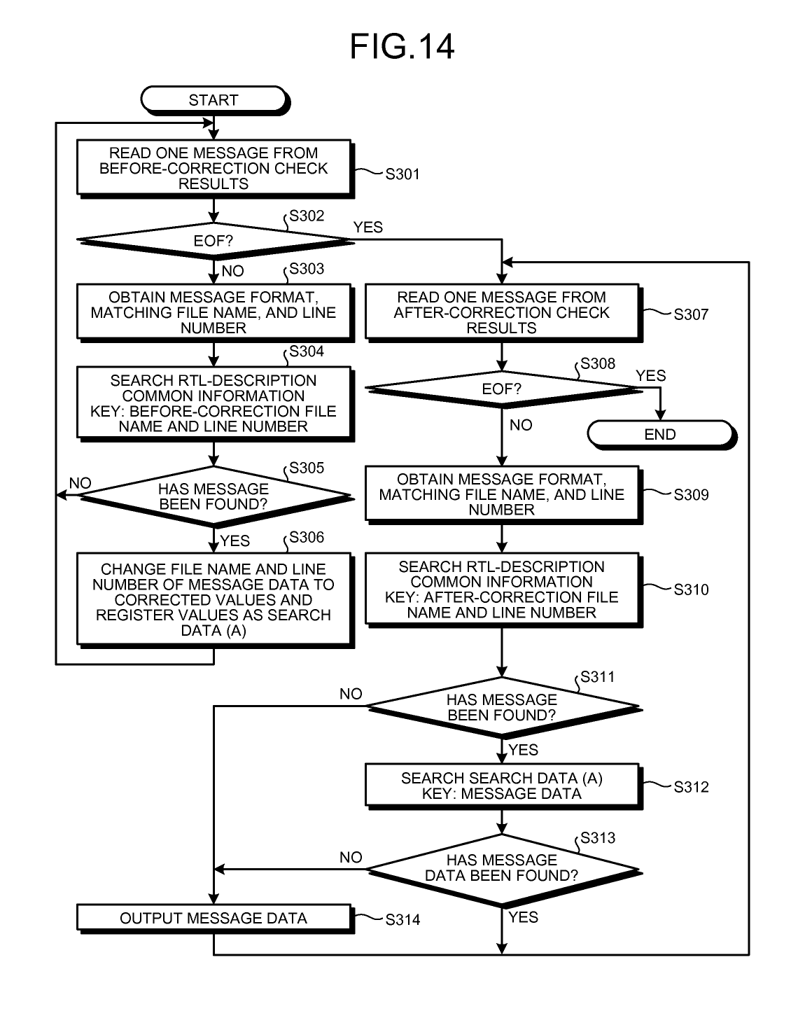

The style-check-difference extracting unit 13e then performs the process for extracting differences between the results of the style check tool A and the results of the style check tool B using the check results, the RTL-description common information, and the first message dictionary (the process will be described in details later with reference to FIG. 14).

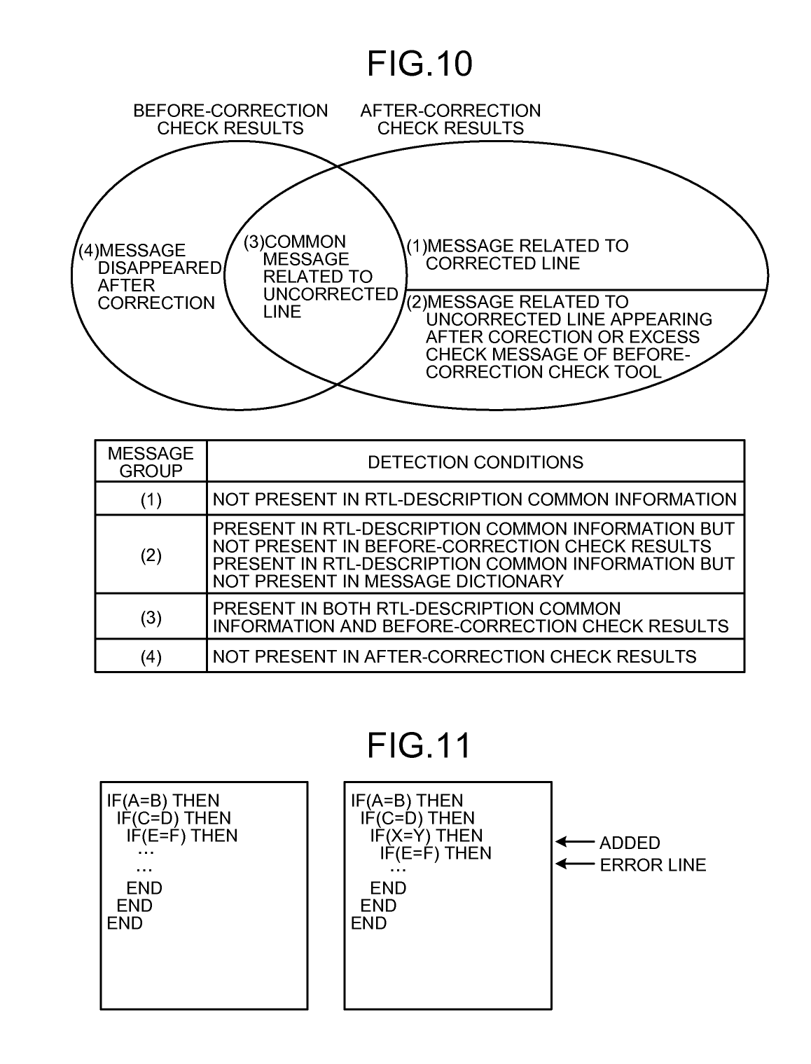

Before extracting differences between the results of the style check tool A and the results of the style check tool B, a process is performed for separating messages of the check results into groups. The process for separating messages of the check results into groups is described with reference to FIG. 10. FIG. 10 is a schematic diagram that illustrates how messages are separated into groups.

As illustrated FIG. 10, the style-check-difference extracting unit 13e determines whether each message satisfies certain detection conditions and separates each message into any of groups (1) to (4). The style-check-difference extracting unit 13e then extracts the message groups (1) and (2) as differences between the results of the style check tool A and the results of the style check tool B.

The detection condition of the message group (1) is whether the message is not present in the RTL-description common information. In other words, any message of the message group (1) is a new message related to a corrected line and such messages are extracted as differences between the results of the style check tool A and the results of the style check tool B.

Any message of the message group (2) is either a message that is present in the RTL-description common information but not in the before-correction check result or a message that is present in the RTL-description common information but not in the message dictionary.

Any message that belongs to the message group (2) is either a message related to an uncorrected line appearing after correction or an excess check message of the before-correction check tool. The message group (2) is also extracted as differences between the results of the style check tool A and the results of the style check tool B.

An example of a message that belongs to the message group (2) is described with reference to FIG. 11. FIG. 11 is a schematic diagram that illustrates how differences between the style check results are extracted. As illustrated in FIG. 11, the line “IF(X=Y)THEN” that is added to a position before the error line affects the line “IF(E=F)THEN”. Although the line “IF(E=F)THEN” is uncorrected, the line is extracted as a difference.

In other words, in the example of FIG. 11, although the contents of “IF(E=F)THEN” are uncorrected, because the IF sentence “IF(X=Y)THEN” is added, there is a possibility that the depth exceeds the defined value of IF sentences. This is why any message related to an uncorrected line appearing after correction is extracted as a difference. It is allowable to give a notice about the effects of the added line (e.g., the depth of the IF sentence exceeds the defined value) and the IF sentence before the error line.

As described above, the RTL style check itself makes a check, taking RTL/hardware into consideration and simply extracts differences between before correction and after correction. This helps improvement of the user's RTL description quality, improvement in the quality, and reduction of man-hours.

The message group (3) includes messages that are present in the RTL-description common information and also present in the before-correction check result. In other words, any message of the message group (3) is a common message related to an uncorrected line. Because the message that belongs to the message group (3) is the same as a result of the style check tool A and a result of the style check tool B, such a message is not extracted as a difference.

The message group (4) includes massages that are not present in the after-correction check result. In other words, any message that belongs to the message group (4) is a message disappeared after correction. Since such messages are not needed to output as differences, they are not extracted as differences.

As described above, the messages that belong to the message groups (1) and (2) are extracted as differences between the results of the style check tool A and the results of the style check tool B and the extracted messages are outputs via the output unit 12.

Processes Performed by the Logical Design Aiding Apparatus

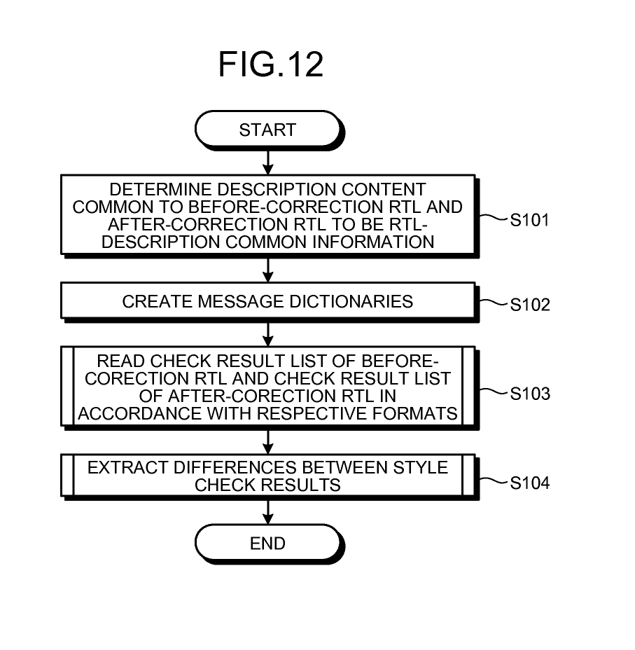

Processes performed by the logical design aiding apparatus 10 are described below with reference to FIGS. 12 to 14 according to the second embodiment. FIGS. 12 to 14 are sequence diagrams of processes performed by the logical design aiding apparatus according to the second embodiment.

As illustrated in FIG. 12, the RTL-description common information creating unit 13a of the logical design aiding apparatus 10 creates the RTL-description common information that includes description contents that are common to both the before-correction RTL and the after-correction RTL (Step S101). The message-dictionary creating unit 13b of the logical design aiding apparatus 10 performs a message-dictionary creating process (Step S102). The message-dictionary creating process will be described in details later with reference to FIGS. 13A and 13B.

After that, the style-check-result input unit 13c of the logical design aiding apparatus 10 reads the before-correction check result list and the after-correction check result list in accordance with the formats (Step S103). The style-check-difference extracting unit 13e of the logical design aiding apparatus 10 then performs the process for extracting differences between the style check results (Step S104). The difference extracting process will be described in details later with reference to FIG. 14.

The message-dictionary creating process performed by the logical design aiding apparatus 10 is descried below with reference to FIGS. 13A and 13B according to the second embodiment. As illustrated in FIGS. 13A and 13B, the message-dictionary creating unit 13b of the logical design aiding apparatus 10 checks the style of the same RTL using both the style check tool A and the style check tool B.

After that, the message-dictionary creating unit 13b extracts the line numbers and the message main bodies from the result files that contain results of the style check, creates the correspondence table A and the correspondence table B by relating the line numbers to the message main bodies and storing them in the correspondence table A and the correspondence table B (Step S201).

After that, the message-dictionary creating unit 13b compares the correspondence table A with the correspondence table B and extracts an unpaired message (Step S202). The message-dictionary creating unit 13b then determines whether the extracted message is registered on the second message dictionary (Step S203).

If the extracted message is not registered (No at Step S203), the message-dictionary creating unit 13b registers the message and the identifier on the second message dictionary, the identifier indicative of either the check tool A or B (Step S204).

After that, the message-dictionary creating unit 13b compares the correspondence table A with the correspondence table B and extracts messages that are related to the same line and in a one-to-one relation (Step S205) and determines whether the messages are registered on the second message dictionary (Step S206).

If the extracted messages are not registered on the second message dictionary (No at Step S206), the message-dictionary creating unit 13b registers the messages and the identifiers on the first message dictionary, the identifiers indicative of either the check tool A or B (Step S207).

Subsequently, the message-dictionary creating unit 13b compares the correspondence table A with the correspondence table B, extracts messages that are related to the same line and present over several lines, and determines the messages to be messages possible to be matched messages (Step S208). The message-dictionary creating unit 13b then determines whether the extracted messages A and B are registered on the second message dictionary (Step S209).

If the extracted messages A and B are registered on the second message dictionary (Yes at Step S209), the message-dictionary creating unit 13b deletes the message from the messages possible to be matched messages (Step S210).

After that, the message-dictionary creating unit 13b determines whether the extracted message A is registered on the first message dictionary (Step S211). If the extracted message A is registered, the message-dictionary creating unit 13b determines whether the message B is registered on the first message dictionary (Step S212).

If the message B is registered on the first message dictionary (Yes at Step S212), the message-dictionary creating unit 13b deletes the message from the messages possible to be matched messages (Step S213). On the other hand, if the message B is not registered on the first message dictionary (No at Step S212), the message-dictionary creating unit 13b deletes the message from the first message dictionary and registers the message on the second message dictionary (Step S214).

After that, the message-dictionary creating unit 13b determines whether the message B is registered on the first message dictionary (Step S215). If the message B is registered (Yes at Step S215), the message-dictionary creating unit 13b deletes the message from the first message dictionary and registers the message on the second message dictionary (Step S216).

The message-dictionary creating unit 13b then determines a remaining message is in a one-to-one relation (Step S217). If a remaining message is in a one-to-one relation (Yes at Step S217), the message-dictionary creating unit 13b registers the message on the first message dictionary (Step S218). If a remaining message is not in a one-to-one relation (No at Step S217), the message-dictionary creating unit 13b registers the message on the third message dictionary (Step S219).

After that, the message-dictionary creating unit 13b determines whether all the messages have been processed (Step S220). If all the messages have not been processed (No at Step S220), the process control returns to Step S208. If all the messages have been processed (Yes at Step S220), the message-dictionary creating process goes to end.

The style-check-result difference extracting process performed by the logical design aiding apparatus 10 is described below with reference to FIG. 14 according to the second embodiment. As illustrated in FIG. 14, the style-check-result input unit 13c of the logical design aiding apparatus 10 reads an immediately previous message from the before-correction check result (Step S301).

The style-check-result input unit 13c of the logical design aiding apparatus 10 determines whether it is an end-of-file (Step S302). If it is not an end-of-file (No at Step S302), the style-check-result input unit 13c obtains the message format, the matching file name, and the line number (Step S303).

The style-check-difference extracting unit 13e then searches the RTL-description common information using the obtained file name and the obtained line number of the before-correction check result as keys (Step S304). If message data having the same file name and the same line number is found in the RTL-description common information (Yes at Step S305), the style-check-difference extracting unit 13e changes the file name and the line number of the message data to corrected values (Step S306).

During the process, the message replacing unit 13d searches the first message dictionary using the message as a key. If a message having the same content is found, the message is replaced with the message of the style check tool B and then the message of the style check tool B is registered on search data (A). If no message having the same contents is found, the message is registered on the search data (A) as it is.

After that, the process control returns back to Step S301, and the processes from Steps S301 to S306 are repeated. If, in the process at Step S302, it is determined to be an end-of-file (Yes at Step S302), the style-check-result input unit 13c reads one piece of data from the after-correction check result (Step S307).

The style-check-result input unit 13c then determines whether it is an end-of-file (Step S308). If it is not an end-of-file (No at Step S308), the style-check-result input unit 13c obtains the message format, the matching file name, and the line number (Step S309).

The style-check-difference extracting unit 13e then searches the RTL-description common information using the obtained file name and the obtained line number of the after-correction check result as keys (Step S310). If message data having the same file name and the same line number is found in the RTL-description common information (Yes at Step S311), the style-check-difference extracting unit 13e searches the search data (A) using the message data as a key (Step S312).

If the same message data is found in the search data (A) (Yes at Step S313), the process control returns to Step S307 and the message data is not output as a difference between the check results. In other words, the message data is a message that is present in both the RTL-description common information and the before-correction check result, i.e., the message belongs to the “message group (3)”; therefore, the message data is not output as a difference between the check results.

If the same message data is not found in the search data (A) (No at Step S313), the style-check-difference extracting unit 13e outputs the message data as a piece of differential information (Step S314). In other words, the message data is either a message that is present in the RTL-description common information but is not present in the before-correction check result or a message that is present in the RTL-description common information but is not present in the message dictionary, i.e., the message data belongs to the “message group (2)”; therefore, the message data is output as a difference between the check results.

If, at Step S311, no message data having the same file name and the same line number is found (No at Step S311), the style-check-difference extracting unit 13e outputs the message data as a piece of differential information between the check results (Step S314). In other words, the message data is a message that is not present in the RTL-description common information, i.e., the message data belongs to the “message group (1)”; therefore, the message data is output as a difference between the check results.

If, at Step S308, the style-check-result input unit 13c determines it is an end-of-file (Yes at Step S308), the style check result difference extracting process goes to end.

### Effects of the Second Embodiment

As described above, the logical design aiding apparatus 10 identifies the positional relation between the position of an uncorrected description part of the after-correction logical description and the position of the corresponding description part of the before-correction logical description. During the logical description difference extracting method, using the identified positional relation, a position is identified where the before-correction check results are accordant with the after-correction check results. After that, message replacement is conducted so that the format of a message of a before-correction check result located on the identified position is changed to the same format as the format of messages of the after-correction check results. Differences are then extracted between the format-changed before-correction check results and the after-correction check results. With this configuration, differences are extracted exactly between results of check using different style check tools in order to help designing hardware description language.

Moreover, in the second embodiment, the logical design aiding apparatus 10 has a message dictionary that contains messages of the before-correction check results and messages of the after-correction check results in an associated manner. The logical design aiding apparatus 10 conducts message replacement using the message dictionary so that the format of messages of the before-correction check results is changed to the same format as the format of messages of the after-correction check results. As described above, different formats of the different style check tools are easily changed to a uniformed format using the message dictionary; therefore, differences are extracted exactly even between results of check using different style check tools in order to help designing hardware description language.

Moreover, in the second embodiment, the logical design aiding apparatus 10 checks the logical description using the first style check tool thereby obtaining first check results and also checks the same logical description using the second style check tool, thereby obtaining second check results. The logical design aiding apparatus 10 then relates a message of a first check result to a message of a second check result that is located on the same position as the message and stores the messages in a message dictionary. With this configuration, a message dictionary is created for format change between the first style check tool and the second style check tool and then differences are extracted exactly even between results of checks using different style check tools in order to help designing hardware description language.

### [c] Third Embodiment

Although the present invention are embodied variously as described in the above, the present invention can be embodied yet another way. In the following, some other embodiments of the present invention are described as the third embodiment.

(1) Message Dictionary

Although, in the above-described second embodiment, the message dictionaries are created, the present embodiment is not limited thereto. It is allowable to create the message dictionaries in advance and stores messages in the message dictionaries.

(2) System Configuration, Etc.

The constituent elements of each device illustrated in the drawings are merely conceptual, and need not be physically configured as illustrated. The constituent elements, as a whole or in part, can be separated or integrated either functionally or physically based on various types of loads or use conditions. For example, the message replacing unit 13d and the style check difference extracting unit can be integrated as one unit.

(3) Program

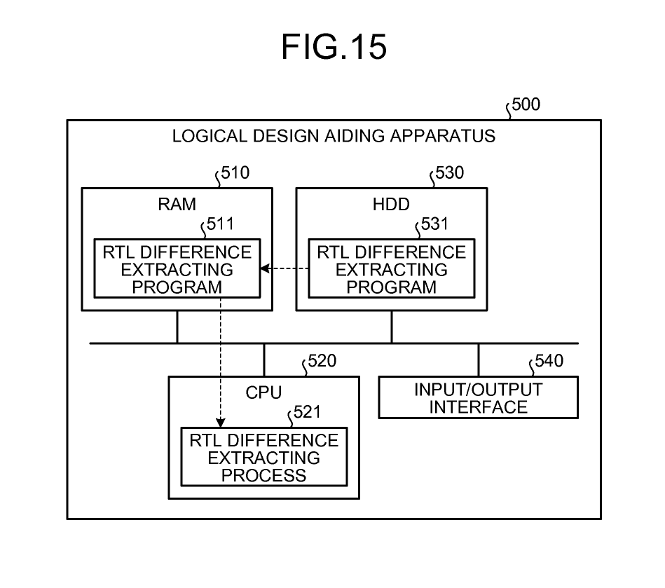

The various processes that are described in the first embodiment and the second embodiment can be realized by a computer system, such as a personal computer and a work station, executing a prepared program. An example of a computer is described below with reference to FIG. 15 that executes a logical description difference extracting program, thereby realizing the same functions as those in the first embodiment and the second embodiment. FIG. 15 is a block diagram of a computer that executes the logical description difference extracting program.

As illustrated in FIG. 15, a computer 500 that functions as the logical design aiding apparatus includes a RAM 510, a CPU 520, an HDD 530, and an input/output interface 540, all of which being connected to each other via a bus or like.

The input/output interface 540 inputs contents of the before-correction RTL-based hardware description (hereinafter, “RTL1”), contents of the after-correction RTL-based hardware description (hereinafter, “RTL2”), results of checks for the hardware descriptions using the style check tools, etc.

The input/output interface 540 outputs differences between results of a check for the before-correction hardware description using a style check tool and results of a check for the after-correction hardware description using a style check tool. The HDD 530 stores therein information that is needed when the CPU 520 performs various processes. The RAM 510 stores therein information as temporary data. The CPU520 executes various computing processes.

The HDD 530 prestores therein, as illustrated in FIG. 15, an RTL difference extracting program 511 that brings the same functions as those of the units described in the first embodiment and the second embodiment. It is allowable to store a part of the RTL difference extracting program 511 in a storage unit of another computer that is connected to the computer 500 via a network.

The CPU 520 reads the RTL difference extracting program 511 from the HDD 530 and loads it on the RAM 510. The RTL difference extracting program 511 then reads various data from the HDD 530, loads them on an area of the RAM 510 that is assigned to the RTL difference extracting program 511, and performs various processes in accordance with the loaded data.

The RTL difference extracting program 511 does not need to be present in the HDD 530 by default. For example, the program can be stored in a “portable physical medium” insertable to the computer 500, such as a flexible disk (FD), a CD-ROM, a DVD disk, a magnetic optical disk, or an IC card or “another computer (or server)” that is connected to the computer 500 via the public line, the Internet, a LAN, a WAN, or the like. The computer 500 reads the program from them and executes the program.

According to an embodiment of the logical description difference extracting method disclosed in the subject application, differences are extracted exactly between results of checks using different style check tools in order to help designing hardware description language.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A logical description difference extracting method comprising:
extracting a difference between before-correction check results and after-correction check results, wherein the before-correction check results are results of a check for a before-correction logical description using a first style check tool, the after-correction check results are results of a check for an after-correction logical description using a second style check tool, and a format of messages of the first style check tool is different from a format of messages of the second style check tool;
identifying a positional relation between a position of an uncorrected description part of the after-correction logical description and a position of a corresponding description part of the before-correction logical description;
identifying, using the positional relation identified in the identifying, a position where the before-correction check results are accordant with the after-correction check results and conducting message replacement so that the format of a message of a before-correction check result located on the identified position is changed to the same format as the format of messages of the after-correction check results; and
extracting a difference between the before-correction check results format-changed in the message replacement and the after-correction check results.

2. The logical description difference extracting method according to claim 1, wherein the message replacement includes conducting, using a message dictionary that relates messages of the before-correction check results to messages of the after-correction check results, message replacement so that the format of messages of the before-correction check results are changed to the same format as the format of messages of the after-correction check results.

3. The logical description difference extracting method according to claim 2, further comprising
checking a logical description using the first style check tool, thereby obtaining first check results and checking the same logical description using the second style check tool, thereby obtaining second check results; relating a message of a first check result to a message of a second check result located on the same position as the position of the message of the first check result; and storing the messages in the message dictionary.

4. A logical design aiding apparatus comprising:
an extraction unit that extracts a difference between before-correction check results and after-correction check results, wherein the before-correction check results are results of a check for a before-correction logical description using a first style check tool, the after-correction check results are results of a check for an after-correction logical description using a second style check tool, and a format of messages of the first style check tool is different from a format of messages of the second style check tool;
an identifying unit that identifies a positional relation between a position of an uncorrected description part of the after-correction logical description and a position of a corresponding description part of the before-correction logical description;
a conducting unit that identifies, using the positional relation identified by the identifying unit, a position where the before-correction check results are accordant with the after-correction check results and conducts message replacement so that the format of a message of a before-correction check result located on the identified position is changed to the same format as the format of messages of the after-correction check results; and
an extracting unit that extracts a difference between the before-correction check results format-changed in the message replacement and the after-correction check results.

5. A non-transitory computer-readable storage medium stored therein a logical description difference extracting program, the program causing a computer to execute a process comprising:
extracting a difference between before-correction check results and after-correction check results, wherein the before-correction check results are results of a check for a before-correction logical description using a first style check tool, the after-correction check results are results of a check for an after-correction logical description using a second style check tool, and a format of messages of the first style check tool is different from a format of messages of the second style check tool;
identifying a positional relation between a position of an uncorrected description part of the after-correction logical description and a position of a corresponding description part of the before-correction logical description;
identifying, using the positional relation identified in the identifying, a position where the before-correction check results are accordant with the after-correction check results and conducting message replacement so that the format of a message of a before-correction check result located on the identified position is changed to the same format as the format of messages of the after-correction check results; and
extracting a difference between the before-correction check results format-changed in the message replacement and the after-correction check results.

6. A logical design aiding apparatus comprising:
a processor; and
a memory, wherein the processor configured to execute a process comprising:
extracting a difference between before-correction check results and after-correction check results, wherein the before-correction check results are results of a check for a before-correction logical description using a first style check tool, the after-correction check results are results of a check for an after-correction logical description using a second style check tool, and a format of messages of the first style check tool is different from a format of messages of the second style check tool;
identifying a positional relation between a position of an uncorrected description part of the after-correction logical description and a position of a corresponding description part of the before-correction logical description;
identifying, using the positional relation identified in the identifying, a position where the before-correction check results are accordant with the after-correction check results and conducting message replacement so that the format of a message of a before-correction check result located on the identified position is changed to the same format as the format of messages of the after-correction check results; and
extracting a difference between the before-correction check results format-changed in the message replacement and the after-correction check results.
